(19) United States
(12) Patent Application Publication
(10) Pub. No.: US 2014/0344483 A1
(43) Pub. Date: Nov. 20, 2014

(54) MONITORING SYSTEM AND METHOD FOR MONITORING HARD DISK DRIVE WORKING STATUS

(71) Applicants: Hon Hai Precision Industry Co., Ltd., New Taipei (TW); Hong Fu Jin Precision Industry (ShenZhen) Co., Ltd., Shenzhen (CN)

(72) Inventor: LIANG CHEN, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 14/103,844

(22) Filed: Dec. 12, 2013

(30) Foreign Application Priority Data
May 20, 2013 (CN) 2013101860208

(51) Int. Cl. G06F 11/32; G06F 11/30

(52) U.S. Cl. CPC G06F 11/328; G06F 11/3055
USPC 710/19

(57) ABSTRACT

A monitoring system for monitoring working statuses of hard disk drives comprises a controller, an MCU, an RS, and a group of indicators. The controller stores SGPIO information of corresponding hard disk drives. The MCU comprises an SGPIO signal reading unit and an SGPIO signal decoding unit. The SGPIO signal reading unit is configured for reading the SGPIO information. The SGPIO signal decoding unit decodes the read SGPIO information to obtain working status information and sends the obtained working status information to the RS. The RS receives the working status information. The group of indicators indicates the working statuses of the corresponding hard disk drives. A monitoring method using the monitoring system is also provided.

### BACKGROUND

1. Technical Field

The present disclosure relates to monitoring system and methods, and particularly to a monitoring system and a method for monitoring working statuses of hard disk drives.

2. Description of Related Art

Data centers may comprise a plurality of hard disk drives. As data centers require more and more hard disk drives, it becomes increasingly important to monitor working statuses of the hard disk drives. Therefore, a monitoring system and method for easily monitoring working statuses of the hard disk drives is necessary.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a monitoring system for monitoring working statuses of a plurality of hard disk drives.

FIG. 2 is a flowchart of one embodiment of a monitoring method for monitoring the working statuses of the plurality of hard disk drives using the monitoring system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

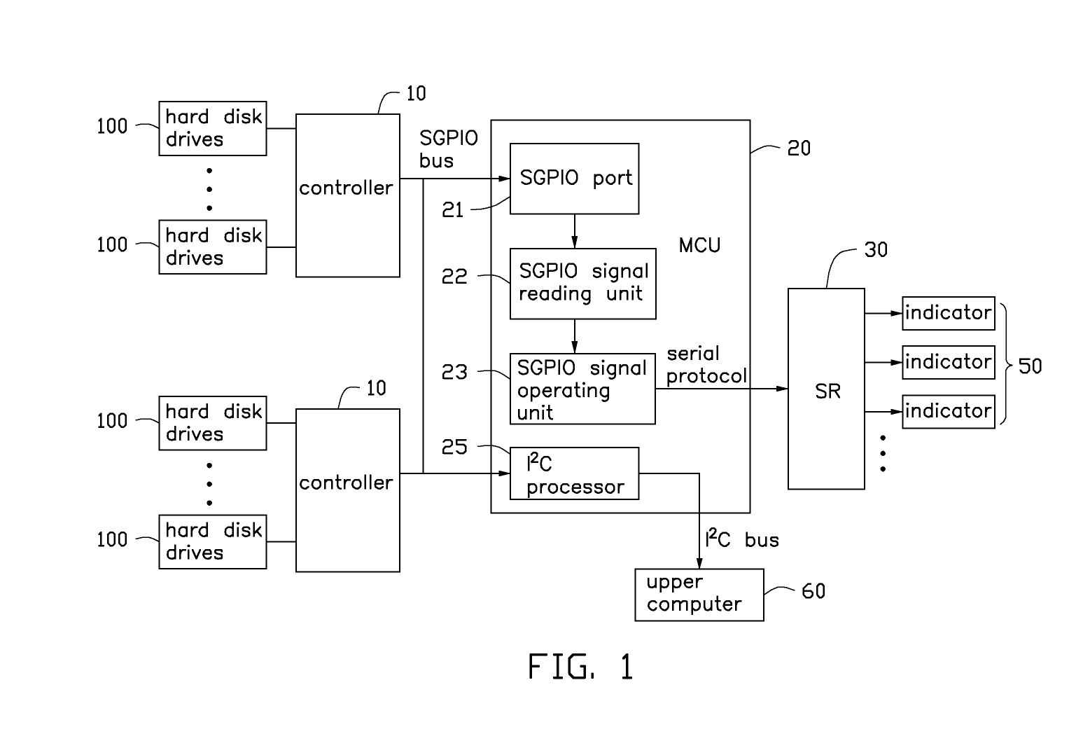

FIG. 1 shows one embodiment of a monitoring system for monitoring working statuses of a plurality of hard disk drives 100. The monitoring system comprises a plurality of controllers 10, a Micro Control Unit (MCU) 20, a Shift Register (SR) 30, and a plurality of indicators 50. The controllers 10, the MCU 20, the SR 30, and the plurality of indicators 50 are secured to a backboard (not shown) of one of the hard disk drives 100.

In one embodiment, the controllers 10 are connected to corresponding hard disk drives 100 and control the plurality of hard disk drives 100. The controllers 10 store Serial General Purpose Input/Output (SGPIO) information and basic information of each hard disk drive 100. The SGPIO information comprises working status information of a corresponding hard disk drive 100. For example, when the hard disk drives 100 work normally, the corresponding working status information is 01; when one of the hard disk drives 100 works abnormally, the corresponding working status information is 10. The basic information comprises a serial number and a manufacturer name of the corresponding hard disk drive 100.

The MCU 20 comprises an SGPIO port 21, an SGPIO signal reading unit 22, an SGPIO signal operating unit 23, and an I²C processor 25.

The SGPIO port 21 is connected to the controller 10 through a SGPIO bus.

The SGPIO signal reading unit 22 is used for reading the SGPIO information sent by the controller 10 through the SGPIO port 21.

The SGPIO signal operating unit 23 is used for operating the SGPIO information read by the SGPIO signal reading unit 21 and sending the operated SGPIO information to the SR 30. A process of the SGPIO signal operating unit 23 operating the read SGPIO information comprises decoding the read SGPIO information and comparing the decoded SGPIO information with preset SGPIO information in the SGPIO signal operating unit 23. The working status information of the corresponding hard disk drive 100 is obtained from the comparing result.

An input end of the I²C processor 25 is connected to the controller 10 to receive the basic information from the controller 10. An output end of the I²C processor 25 is connected to a master computer 60 to send the SGPIO information and the basic information of the hard disk drives 100 to the master computer 60.

An input end of the RS 30 is connected to the SGPIO signal operating unit 23 to receive the working status from the operated SGPIO signal. An output end of the RS 30 is connected to the indicators 50 to indicate the working statuses. Each hard disk drive 100 corresponds to a group of indicators 50. In one embodiment, each group of indicators 50 comprises a green indicator and a yellow indicator. When the working status of the hard disk drive 100 is normal, the green indicator is lit. When the working status of the hard disk drive 100 is abnormal, the yellow indicator is lit.

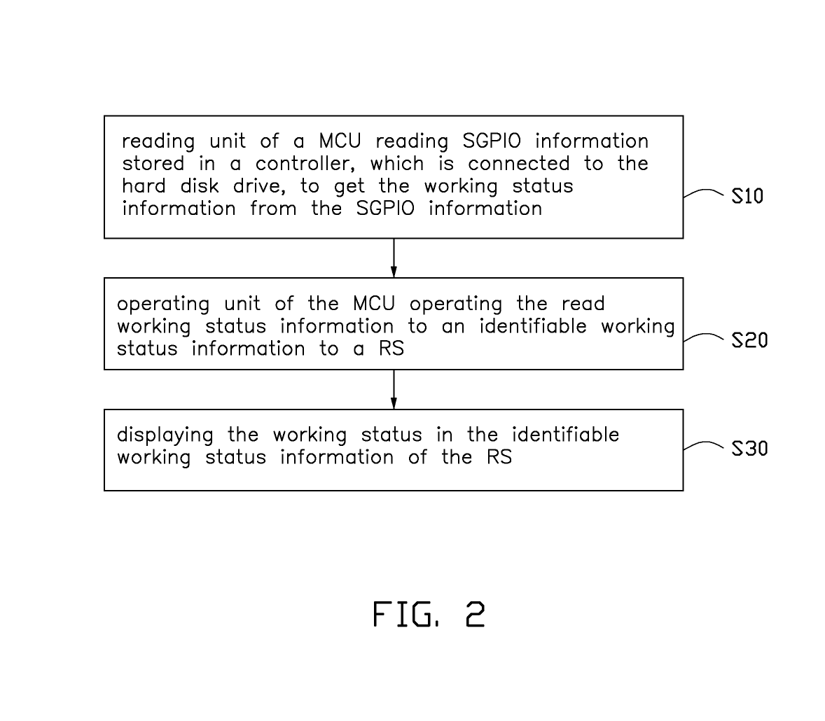

FIG. 2 shows one embodiment of a monitoring method for monitoring working statuses of the plurality of hard disk drives 100.

In step S10, the SGPIO signal reading unit 22 reads the SGPIO information sent by the controller 10 through the SGPIO port 21.

In step S20, the SGPIO signal operating unit 23 decodes the read SGPIO information and compares the decoded SGPIO information with the preset SGPIO information in the SGPIO signal operating unit 23, thereby obtaining the working status information of the corresponding hard disk drive 100. The SGPIO signal operating unit 23 sends the working status information obtained from the comparing result to the RS 30.

In step S30, the RS 30 indicates the working status of the corresponding hard disk drives 100 through the indicators 50.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A monitoring system, for monitoring a working status of a hard disk drive, comprising:
a controller connected to the hard disk drive and storing SGPIO information;
a MCU connected to the controller and comprising a SGPIO signal reading unit and a SGPIO signal operating unit;
a RS connected to the MCU; and
a group of indicators connected to the RS;
wherein the SGPIO signal reading unit is configured for reading the SGPIO information to obtain a working status from the SGPIO information; the SGPIO signal operating unit is configured for operating the working status information to an identifiable working status information to the RS; the RS is configured for receiving the identifiable working status information; and the group of indicators is configured for displaying the working status in the identifiable working status information.

2. The monitoring system of claim 1, wherein the MCU further comprises an I²C processor; the controller further stores basic information of the hard disk drive, and the I²C processor is configured for sending the SGPIO information and the basic information to an master computer.

3. The monitoring system of claim 1, wherein the MCU further comprises a SGPIO port connected to the SGPIO signal reading unit, and the SGPIO signal reading unit reads the SGPIO information through the SGPIO port.

4. The monitoring system of claim 3, wherein the SGPIO signal reading unit is connected to the SGPIO signal operating unit.

5. The monitoring system of claim 3, wherein the SGPIO signal operating unit operates the read working status information comprises decoding the SGPIO information and comparing the decoded SGPIO information with preset SGPIO information in the SGPIO signal operating unit, to obtain the identifiable working status information of the hard disk drive.

6. The monitoring system of claim 3, wherein the SGPIO port is connected to the controller through a SGPIO bus.

7. A monitoring method, for monitoring a working status of a hard disk drive, the method comprising:
reading SGPIO information stored in a controller connected to the hard disk drive, to obtain the working status information from the SGPIO information;
operating the read working status information to an identifiable working status information to a RS;
receiving the identifiable working status information; and
displaying the working status in the identifiable working status information of the RS.

8. The monitoring method of claim 7, wherein the controller further stores basic information of the hard disk drive, and the SGPIO information and the basic information are sent to an master computer by an I²C processor.

9. The monitoring method of claim 7, wherein an MCU comprises a SGPIO signal reading unit and a SGPIO port connected to the SGPIO signal reading unit, and the SGPIO signal reading unit reads the SGPIO information through the SGPIO port.

10. The monitoring method of claim 9, wherein the MCU further comprises a SGPIO signal operating unit connected to the SGPIO signal reading unit.

11. The monitoring method of claim 9, wherein the SGPIO signal operating unit operates the read working status information by decoding the SGPIO information and comparing the decoded SGPIO information with preset SGPIO information in the SGPIO signal operating unit, to obtain the identifiable working status information of the hard disk drive to the RS.

12. The monitoring method of claim 9, wherein the SGPIO port is connected to the controller through a SGPIO bus.

13. A monitoring method, for monitoring a working status of a hard disk drive, the method comprising:
reading unit of a MCU reading SGPIO information stored in a controller connected to the hard disk drive, to obtain the working status information from the SGPIO information;
operating unit of the MCU decoding the SGPIO information and comparing the decoded SGPIO information with preset SGPIO information in the SGPIO signal operating unit, to obtain an identifiable working status information of the corresponded hard disk drive to a RS;
receiving the identifiable working status information; and
displaying the working status in the identifiable working status information of the RS.

14. The monitoring method of claim 13, wherein the controller further stores basic information of the hard disk drive, and the SGPIO information and the basic information are sent to a master computer by an I²C processor.

15. The monitoring method of claim 13, wherein an MCU comprises a SGPIO signal reading unit and a SGPIO port connected to the SGPIO signal reading unit, and the SGPIO signal reading unit reads the SGPIO information through the SGPIO port.

16. The monitoring method of claim 15, wherein the MCU further comprises a SGPIO signal operating unit connected to the SGPIO signal reading unit.

17. The monitoring method of claim 15, wherein the SGPIO port is connected to the controller through a SGPIO bus.
